(19) United States
(12) Patent Application Publication
(10) Pub. No.: US 2025/0319770 A1
(43) Pub. Date: Oct. 16, 2025

(54) Display Device and Vehicle Equipped With Display Device

(71) Applicant: Kubota Corporation, Osaka-shi (JP)

(72) Inventors: Shinya Tabata, Sakai-shi (JP); Taisuke Hashimoto, Sakai-shi (JP); Kohta Nakao, Sakai-shi (JP)

(21) Appl. No.: 19/098,387

(22) Filed: Apr. 2, 2025

(30) Foreign Application Priority Data
Apr. 12, 2024 (JP) 2024-064429

(51) Int. Cl. B60K 35/22; B60K 35/28; B60K 35/81; B60K 35/90

(52) U.S. Cl. CPC B60K 35/22; B60K 35/28; B60K 35/81; B60K 35/90; B60K 2360/167; B60K 2360/169; B60K 2360/178; B60K 2360/46; B60K 2360/61

(57) ABSTRACT

A display device includes an information display section including discrete segments configured to display an alphanumeric character; a drive circuit section configured to selectively switch on and off each of the segments; and a control section configured to control operation of the drive circuit section. The drive circuit section includes a multiple drive circuit configured to simultaneously switch on and off particular segments among the segments of the information display section which are each for a portion of a particular alphanumeric character; and a single drive circuit configured to switch a single segment among the segments of the information display section which is other than the particular segments, the control section being configured to use the multiple drive circuit and the single drive circuit in combination for the control of the operation of the drive circuit section to cause the information display section to display the particular alphanumeric character.

### CROSS-REFERENCE TO RELATED APPLICATION

This application claims priority to Japanese Patent Application No. 2024-064429 filed Apr. 12, 2024, the disclosure of which is hereby incorporated by reference in its entirety.

### BACKGROUND OF THE INVENTION

### Field of the Invention

The present invention relates to a display device including a display section including two or more segments and to a vehicle equipped with the display device.

### Description of Related Art

The above display device may include a display section including sixteen segments for displaying an alphanumeric character. The display device may include separate connection lines for the respective segments to selectively switch each segment on and off (see, for example, Japanese Unexamined Patent Application Publication, Tokukai, No. 2014-170102).

The above configuration involves connection lines for the sixteen respective segments. A display device including many display sections, in particular, includes accordingly many connection lines and an accordingly complex drive circuit section for selectively switching each segment on and off. This unfortunately leads to an increased production cost.

### SUMMARY OF THE INVENTION

The present invention has an object of providing (i) a display device capable of displaying alphanumeric characters and having a simple configuration that allows for cost reduction and (ii) a vehicle equipped with the display device.

A display device according to the present invention includes: an information display section including a plurality of discrete segments configured to display an alphanumeric character; a drive circuit section configured to selectively switch on and off each of the segments; and a control section configured to control operation of the drive circuit section, the drive circuit section including: a multiple drive circuit configured to simultaneously switch on and off a plurality of particular segments among the segments of the information display section which particular segments are each for a portion of a particular alphanumeric character; and a single drive circuit configured to switch a single segment among the segments of the information display section which single segment is other than the particular segments, the control section being configured to use the multiple drive circuit and the single drive circuit in combination for the control of the operation of the drive circuit section to cause the information display section to display the particular alphanumeric character.

The display device is configured to use a multiple drive circuit to simultaneously switch on and off two or more particular segments and a single drive circuit to separately switch on and off each segment other than the particular segments to display a particular alphanumeric character.

The above configuration involves separate single drive circuits for the respective segments other than the particular segments and a single multiple drive circuit for the particular segments. The display device includes fewer connection lines and has a simple configuration, as compared to a case of including separate drive circuits for the respective segments.

The display device is therefore capable of displaying alphanumeric characters and has a simple configuration that allows for cost reduction.

The display device may be further configured such that the information display section includes sixteen segments as the plurality of discrete segments.

The information display section, which includes sixteen segments, is capable of appropriately displaying an alphabetical character.

The display device may be further configured such that the control section is configured to use the multiple drive circuit and the single drive circuit in combination to switch on all the segments of the information display section for a lighting check.

The control section uses a multiple drive circuit for the particular segments and single drive circuits for the other respective segments for a lighting check of all the segments.

A vehicle according to the present invention includes: the display device, wherein the display device is configured to display numeric information on a total distance traveled or a total time length of operation.

The vehicle includes a display device configured to display not only a particular alphabetical character but also the total distance traveled or the total time length of the operation.

### BRIEF DESCRIPTION OF THE DRAWINGS

FIG. 1 is a side view of a utility vehicle.

FIG. 2 is a rear view of a driver section.

FIG. 3 is a block diagram illustrating a display device.

FIG. 4 is a front view of a display device.

FIG. 5 is a diagram illustrating how a drive circuit section is connected for display of numeric characters.

FIG. 6 is a diagram illustrating how single drive circuits are connected to respective segments.

FIG. 7 is a diagram illustrating how single drive circuits are connected to respective segments.

FIG. 8 is a diagram illustrating how a particular alphabetical character string is displayed.

FIG. 9 is a diagram illustrating how a multiple drive circuit is connected to segments.

FIG. 10 is a diagram illustrating how all segments are on.

FIG. 11 is a diagram illustrating how a multiple drive circuit is connected to segments.

### DESCRIPTION OF THE INVENTION

The description below deals with a display device and a utility vehicle as an example vehicle equipped with the display device as embodiments of the present invention with reference to drawings. The present invention is, however, not limited to the embodiment below, and may be altered variously within its scope.

Unless otherwise specified, the description below uses terms such as “front” and “forward” to refer to the direction indicated with arrow F in the drawings, terms such as “back” and “backward” to refer to the direction indicated with arrow B in the drawings, terms such as “left” and “leftward” to refer to the direction indicated with arrow L in the drawings, terms such as “right” and “rightward” to refer to the direction indicated with arrow R in the drawings, terms such as “above” and “upward” to refer to the direction indicated with arrow U in the drawings, and terms such as “below” and “downward” to refer to the direction indicated with arrow D in the drawings.

### Overall Configuration of Utility Vehicle

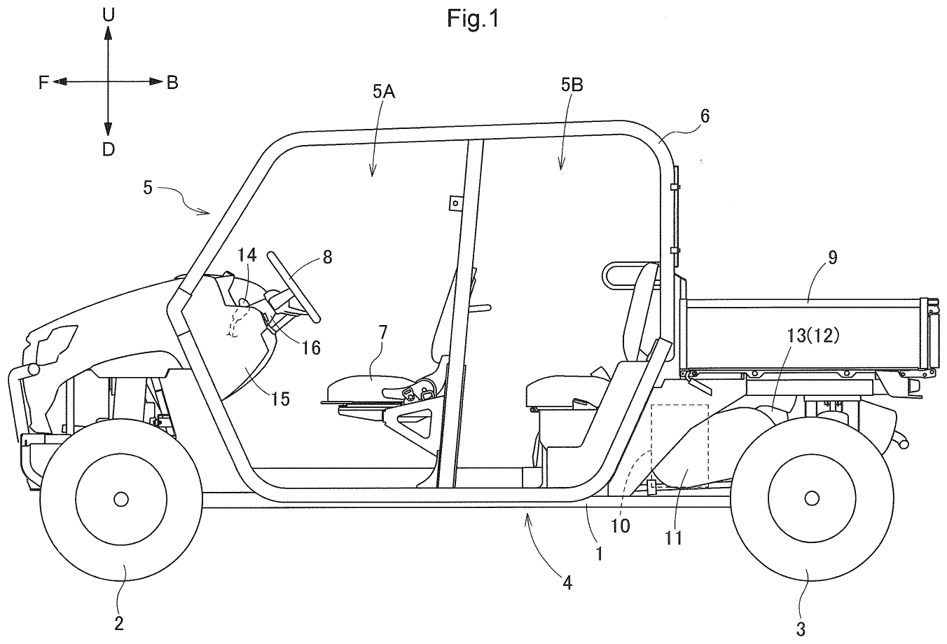

FIG. 1 illustrates a utility vehicle for multiple purposes such as cargo transport and recreation. The utility vehicle includes a body frame 1, a pair of left and right front wheels 2, a pair of left and right rear wheels 3, and a body 4. The front wheels 2 are on a front portion of the body frame 1, and are turnable and drivable. The rear wheels 3 are on a rear portion of the body frame 1, and are drivable.

The utility vehicle includes a driver section 5 disposed at a portion of the body 4 which portion is between the front wheels 2 and the rear wheels 3. The driver section 5 includes a front driver section 5A, a rear driver section 5B, and a roll-over protective structure (ROPS) 6 that defines respective driver spaces of the front and rear driver sections 5A and 5B. The front driver section 5A includes a driver's seat 7 and a driving section 8 forward of the driver's seat 7. The utility vehicle includes a cargo bed 9 backward of the driver section 5 relative to the body 4. The utility vehicle includes below the cargo bed 9 an engine 10 as a motive power source, a belt-type, continuously variable transmission device 11, and a motive power transmission device 12. The continuously variable transmission device 11 is configured to steplessly adjust motive power from the engine 10 and transmit the resulting motive power to the motive power transmission device 12. The motive power transmission device 12 is configured to adjust the motive power from the continuously variable transmission device 11 and transmit the resulting motive power to the front wheels 2 and the rear wheels 3.

The motive power transmission device 12 includes a transmission case 13 and a gear-based power transmission mechanism in the transmission case 13. The motive power transmission device 12 is adjustable in response to a gear-shifting operation into a forward-travel power transmission state, a neutral state, and a rearward-travel power transmission state.

The motive power transmission device 12 receives motive power from the continuously variable transmission device 11, adjusts the motive power with use of the gear-based power transmission mechanism, and transmits the resulting motive power to the front wheels 2 and the rear wheels 3. The motive power transmission device 12 transmits motive power for the rear wheels 3 to a rear-wheel differential mechanism (not illustrated in the drawings) in the transmission case 13. The rear-wheel differential mechanism then transmits the motive power to the rear wheels 3. The motive power transmission device 12 transmits motive power for the front wheels 2 to a front-wheel differential mechanism (not illustrated in the drawings) through a rotary shaft (not illustrated in the drawings) extending forward from the transmission case 13. The front-wheel differential mechanism then transmits the motive power to the front wheels 2.

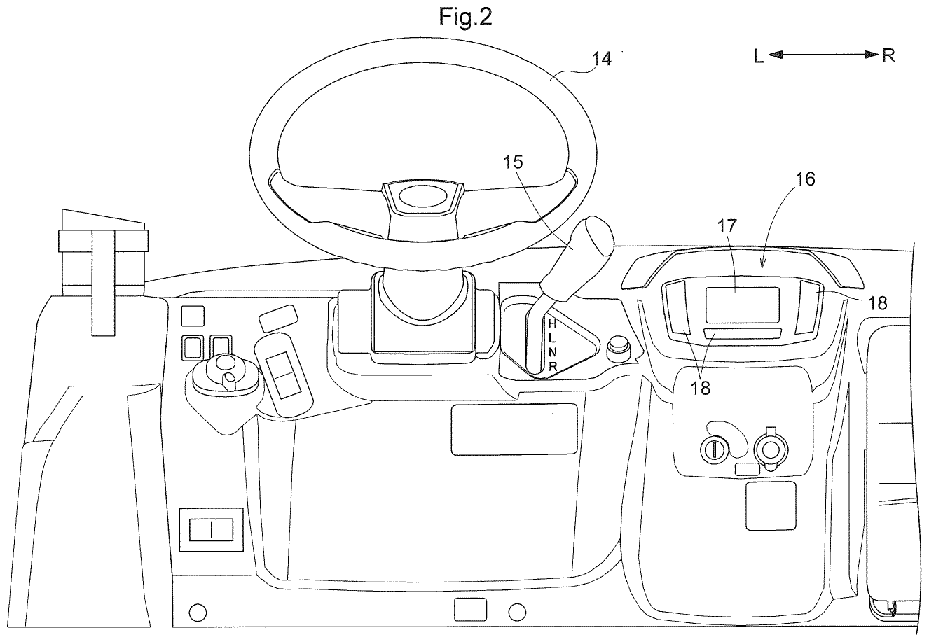

As illustrated in FIG. 2, the driving section 8 includes components such as a steering wheel 14, a shift lever 15, and a display device 16. The steering wheel 14 is disposed forward of the driver's seat 7 for use to turn the front wheels 2. The shift lever 15 is disposed adjacently to the right of the steering wheel 14 and swingable forward and backward. The display device 16 is disposed adjacently to the right of the shift lever 15 and configured to display various items of information.

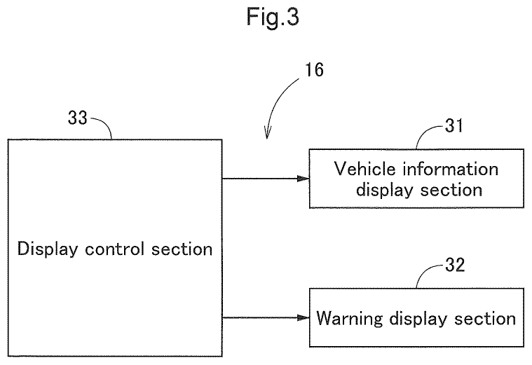

As illustrated in FIG. 3, the display device 16 includes components such as a vehicle information display section 31, a warning display section 32, and a display control section 3. The vehicle information display section 31 is configured to display information such as numerical information on the engine 10 and the vehicle speed. The warning display section 32 includes, for example, various warning lamps in the form of LED lamps. The display control section 33 is configured to control the respective operations of the vehicle information display section 31 and the warning display section 32.

The utility vehicle includes other than the display device 16 components such as a vehicle control section (not illustrated in the drawings) configured to control the overall operation of the vehicle and an engine control section (not illustrated in the drawings) configured to control the operation of the engine 10. The display control section 33 controls the respective operations of the vehicle information display section 31 and the warning display section 32 in response to instructions from the vehicle control section and the engine control section to display intended information.

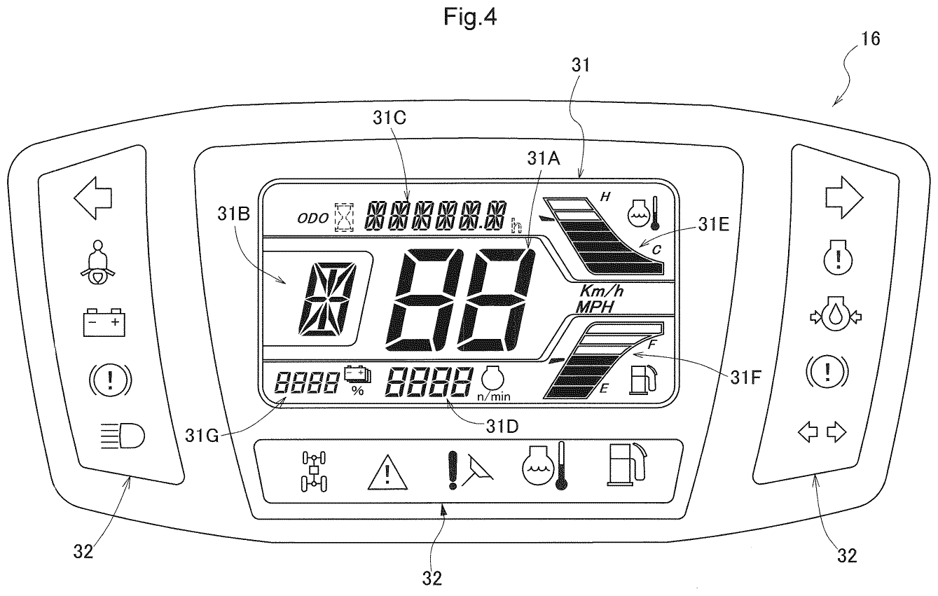

As illustrated in FIG. 4, the vehicle information display section 31 includes liquid crystal display elements serving as components such as a vehicle speed display section 31A for displaying information on the vehicle speed, a gear display section 31B for displaying information on the current position of the shift lever 19, an information display section 31C disposed over the vehicle speed display section 31A for displaying various items of information described later, a rotation speed display section 31D for displaying information on the rotation speed of the engine 10, a temperature display section 31E for displaying information on the temperature of engine cooling water, a remaining fuel display section 31F for displaying information on the amount of remaining fuel, and an auxiliary display section 31G for displaying various other items of information.

The vehicle speed display section 31A includes two seven-segment display portions. The gear speed display section 31B includes a single fourteen-segment display portion. The rotation speed display section 31D includes four seven-segment display portions. The temperature display section 31E includes a seven-segment display portion in the form of a bar. The remaining fuel display section 31F includes a seven-segment display portion in the form of a bar. The auxiliary display section 31G includes four seven-segment display portions.

### Information Display Section

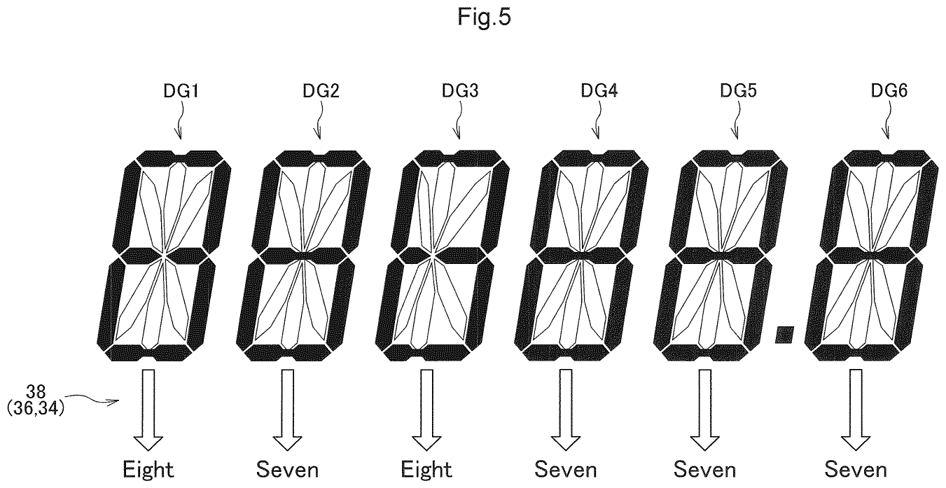

The information display section 31C, as illustrated in FIG. 5, includes six display portions each including sixteen discrete segments for displaying an alphanumeric character. The display portions are each configured to switch each segment on and off to display a particular alphabetical character string and numeric characters. The display portions are namely a first display portion DG1, a second display portion DG2, a third display portion DG3, a fourth display portion DG4, a fifth display portion DG5, and a sixth display portion DG6 from left to right.

The information display section 31C is configured to display (i) numeric information on the total distance traveled or the total time length of the operation of the engine 10 as various items of information and (ii) the text “KUBOTA” indicative of the producer of the vehicle as a particular alphabetical character string.

The display device 16 includes a drive circuit section 34 configured to selectively switch on and off the segments of each display portion of the information display section 31C under control of the display control section 33.

The drive circuit section 34 includes a multiple drive circuit 35 and single drive circuits 36. The multiple drive circuit 35 is configured to simultaneously switch two or more particular segments each for a portion of a particular alphabetical character string or a numeric character. The single drive circuits 36 are each configured to switch a single segment other than the particular segments. The display control section 33 uses the multiple drive circuit 35 and the single drive circuits 36 in combination for the control of the operation of the drive circuit section 34 to display a particular alphabetical character string and numeric characters.

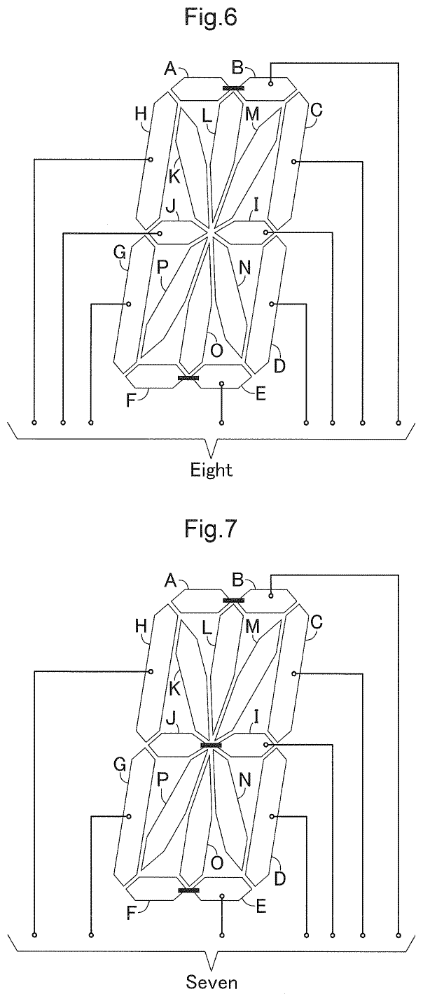

The description below deals with the operation of the display device 16 in detail. The six display portions are configured to switch each of the sixteen segments on and off to display a particular alphabetical character string and numeric characters. As illustrated in FIG. 6, the first display portion DG1 includes sixteen segments A to P. The description below deals with, among all the segments, those for displaying a numeric character. Specifically, segments A and B are connected to each other internally to show as a single segment; segments E and F are connected to each other internally to show as a single segment; and segments C, D, G, H, I, and J each function as a single segment. The above single segments correspond to these eight segments.

The eight segments are for displaying a numeric character, and are each connected to the display control section 33 through a separate connection line 38 to be switched on and off, meaning that the display device 16 includes eight connection lines 38 for the first display portion DG1. The third display portion DG3 includes eight similar segments for displaying a numeric character. The display device 16 includes eight connection lines 38 for the third display portion DG3 as well.

The second, fourth, fifth, and sixth display portions DG2, DG4, DG5, and DG6 each include segments for displaying a numeric character among which, as illustrated in FIG. 7, segments I and J are connected to each other internally to show as a single segment, whereas the other segments are identical to the corresponding ones included in the first display portion DG1. This means that the second, fourth, fifth, and sixth display portions DG2, DG4, DG5, and DG6 each include seven segments for displaying a numeric character which segments are provided with seven respective lines extending out of the display portion.

The drive circuit section 34 thus includes 44 ((8×2)+(7×4)) connection lines 38 in total for displaying numeric characters corresponding to the respective single drive circuits 36.

The six display portions each include, in addition to those segments for displaying a numeric character, six segments around the center, namely, segments K, L, M, N, O, and P. The display control section 33 may switch on these segments together with one or more single segments to display a particular alphabetical character string (that is, the text “KUBOTA”).

Specifically, as illustrated in FIG. 9, segments M and N of the first display portion DG1 are connected to each other internally to show as a single segment; segments L and O of the third display portion DG3 are connected to each other internally to show as a single segment; and segments L and O of the fifth display portion DG5 are connected to each other internally to show as a single segment. The description below uses the term “character-specific segment” to refer to such a seemingly single segment. The three character-specific segments are provided with a single connection line 39.

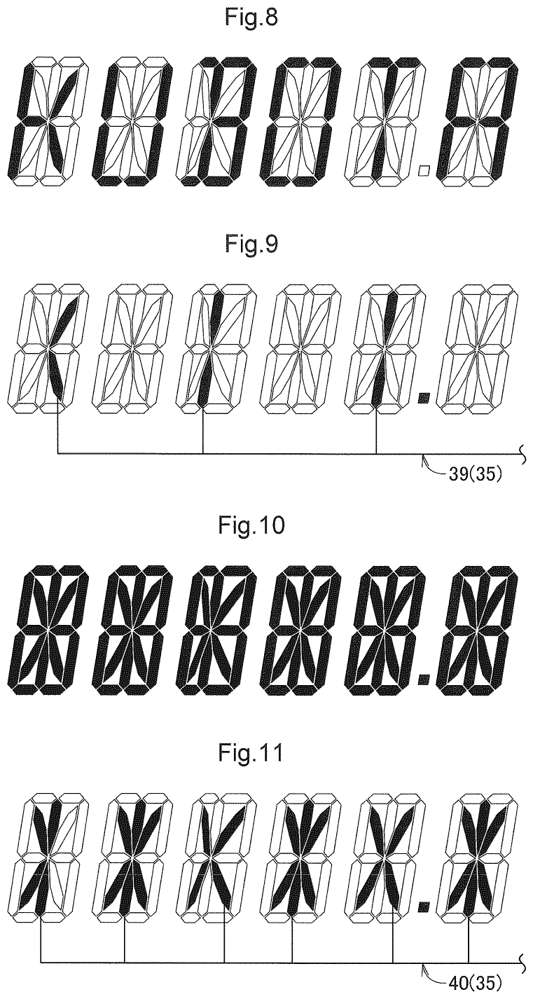

As illustrated in FIG. 8, the display control section 33 switches on the character-specific segments and some segments of the first to sixth display portions DG1 to DG6 to display a particular alphabetical character string (that is, the text “KUBOTA”).

The display control section 33 may switch on segments K, L, M, N, O, and P together with all the single segments to switch on all the segments of the information display section 31C.

Specifically, as illustrated in FIG. 11, segments K, L, O, and P of the first display portion DG1 are connected to one another internally to show as a single segment; segments K, L, M, N, O, and P of the second display portion DG2 are connected to one another internally to show as a single segment; segments K, M, N, and P of the third display portion DG3 are connected to one another internally to show as a single segment; segments K, L, M, N, O, and P of the fourth display portion DG4 are connected to one another internally to show as a single segment; segments K, M, N, and P of the fifth display portion DG5 are connected to one another internally to show as a single segment; and segments K, L, M, N, O, and P of the sixth display portion DG6 are connected to one another internally to show as a single segment. The description below uses the term “all-on segment” to refer to such a seemingly single segment. The six all-on segments are provided with a single connection line 40.

The above particular segments correspond to those segments included in the character-specific segments and those segments included in the all-on segments. The character-specific segments are provided with a connection line 39, whereas the all-on n segments are provided with a connection line 40. The multiple drive circuit 35 corresponds to the two connection lines 39 and 40.

The display control section 33 is configured to, in response to receiving an instruction from the engine control section or the vehicle control section, control the drive circuit section 34 to transmit a signal to each segment intended for the display through the connection line 38 of the corresponding single drive circuit 36. This causes the information display section 31C to display intended numeric information on the total distance traveled or the total time length of the operation of the engine 10.

The display control section 33 is also configured to, in response to receiving an instruction from the engine control section or the vehicle control section, control the drive circuit section 34 to transmit a signal to each segment intended for the display through the connection line 38 of the corresponding single drive circuit 36 and to each character-specific segment through the connection line 39 of the multiple drive circuit 35. This causes the information display section 31C to display a particular alphabetical character string (that is, the text “KUBOTA”) (see FIG. 8).

The display control section 33 is also configured to, in response to receiving an instruction from the engine control section or the vehicle control section, transmit a signal to each segment through the connection line 38 of the corresponding single drive circuit 36 and to each character-specific segment and all-on segment through the connection line 39 or 40 of the multiple drive circuit 35. This causes the information display section 31C to switch on all its segments for a lighting check (see FIG. 10).

If the display device 16 included connection lines separately for the sixteen respective segments of all the six display portions of the information display section 31C, the display device 16 would include 96 (16×6) connection lines in total. The present embodiment, in contrast, includes fewer connection lines, with the result of the drive circuit section 34 having a simple configuration.

### Alternative Embodiments

(1) The embodiment described above is configured to display the text “KUBOTA” indicative of the producer of the vehicle as a particular alphabetical character string. The embodiment may be altered to display another alphabetical character string or two or more alphabetical character strings.

(2) The embodiment described above is configured such that the information display section 31C includes six display portions. The information display section 31C may alternatively include five or less or seven or more display portions.

(3) The embodiment described above is configured such that the information display section 31C includes display portions each including sixteen discrete segments. The present invention is, however, not limited to such a configuration. The display portions may alternatively each include, for example, fourteen segments.

(4) The embodiment described above is configured to switch on all the segments of the information display section 31C for a lighting check. The embodiment may be altered to not perform such a lighting check.

(5) The embodiment described above is configured such that the information display section 31C is in the form of a liquid crystal display device. The display device is, however, not necessarily a liquid crystal display device, and may be any display device such as a light-emitting diode (LED) display device or a vacuum fluorescent display device.

(6) The embodiment described above is a utility vehicle as an example vehicle. The vehicle is, however, not necessarily a utility vehicle, and may be any vehicle equipped with a display device such as an agricultural vehicle or a passenger vehicle.

### INDUSTRIAL APPLICABILITY

The present invention is applicable to a display device including a display section including two or more segments and to a vehicle equipped with the display device.

### REFERENCE SIGNS LIST

31C Information display section
33 Display control section (control section)
34 Drive circuit section
35 Multiple drive circuit
36 Single drive circuit

1. A display device, comprising:
an information display section comprising a plurality of discrete segments configured to display an alphanumeric character;
a drive circuit section configured to selectively switch on and off each of the segments; and
a control section configured to control operation of the drive circuit section, and
wherein:
the drive circuit section comprises:
a multiple drive circuit configured to simultaneously switch on and off a plurality of particular segments among the segments of the information display section which particular segments are each for a portion of a particular alphanumeric character; and
a single drive circuit configured to switch a single segment among the segments of the information display section which single segment is other than the particular segments, and
the control section is configured to use the multiple drive circuit and the single drive circuit in combination for the control of the operation of the drive circuit section to cause the information display section to display the particular alphanumeric character.

2. The display device according to claim 1, wherein:
the information display section comprises sixteen segments as the plurality of discrete segments.

3. The display device according to claim 1, wherein:
the control section is configured to use the multiple drive circuit and the single drive circuit in combination to switch on all the segments of the information display section for a lighting check.

4. The display device according to claim 1, wherein:
the plurality of discrete segments comprise segments connected to each other.

5. The display device according to claim 4, further comprising:
a connection line connecting the control section to one of the segments connected to each other.

6. The display device according to claim 5, wherein:
the display device is configured to switch on all the segments of the information display section.

7. The display device according to claim 6, wherein:
the plurality of discrete segments exceed the connection line in number.

8. A vehicle, comprising:
a display device according to claim 1, and
wherein the display device is configured to display numeric information on a total distance traveled or a total time length of operation.
